(19) United States
(12) Patent Application Publication
(10) Pub. No.: US 2026/0200447 A1
(43) Pub. Date: Jul. 16, 2026

(54) HYBRID ELECTRO-MECHANICAL BRAKE APPARATUS AND CONTROL METHOD THEREFOR

(71) Applicant: HYUNDAI MOBIS CO., LTD., Seoul (KR)

(72) Inventor: Jong Sung KIM, Yongin-si (KR)

(73) Assignee: HYUNDAI MOBIS CO., LTD., Seoul (KR)

(21) Appl. No.: 19/311,491

(22) Filed: Aug. 27, 2025

(30) Foreign Application Priority Data
Jan. 16, 2025 (KR) 10-2025-0006962

(51) Int. Cl. B60T 8/1755; B60T 7/06

(52) U.S. Cl. CPC B60T 8/17551; B60T 7/06; B60T 2270/413; B60T 2270/88

(57) ABSTRACT

Disclosed is a hybrid electro-mechanical brake apparatus and a control method therefor. The hybrid electro-mechanical brake apparatus includes a pedal simulator configured to simulate a depression state of a brake pedal, a data collection module configured to collect vehicle information, a wheel controller configured to drive an electric caliper mounted on either front or rear wheels of a vehicle to generate braking force, a hydraulic control module configured to control a flow path to provide braking pressure to a hydraulic caliper mounted on a wheel different from a wheel on which the electric caliper is installed, based on the depression state of the pedal simulator, and a processor operatively coupled to the data collection module, the wheel controller, and the hydraulic control module, and the processor determines a vehicle posture based on the vehicle information input from the data collection module, drives the hydraulic control module and the wheel controller to perform posture control, and drives the wheel controller and the hydraulic control module according to braking conditions to generate the braking force.

### CROSS-REFERENCE TO RELATED APPLICATION

This application claims the benefit under 35 U.S.C. § 119(a) of priority to Korean Patent Application No. 10-2025-0006962 filed on Jan. 16, 2025, in the Korean Intellectual Property Office, the entire disclosure of which is incorporated herein by reference for all purposes.

### BACKGROUND

### 1. Technical Field

The present disclosure relates to a hybrid electro-mechanical brake apparatus and a control method therefor, and more particularly, to a hybrid electro-mechanical brake apparatus and a control method therefor, which applies an electro-mechanical brake (EMB) to front wheels and a hydraulic caliper to rear wheels to generate rear wheel braking force through a wet-type pedal simulator and an electronic stability control (ESC) system.

### 2. Related Art

A brake system is essential for a vehicle. This is because an unstoppable vehicle cannot be driven. Therefore, for the safety of passengers, the stability of the brake system cannot be overemphasized.

Therefore, the recent brake system uses an electronic master booster instead of the conventional hydraulic system to exhaust and provide braking hydraulic pressure, and adopts an anti-lock brake system (ABS) that shortens braking distances by preventing tire locking during sudden braking and avoiding rapid steering wheel operation to avoid risk, an electrical stability control (ESC) system to maintain a stable position of the vehicle by controlling the braking force and engine output of the vehicle in dangerous situations where the vehicle slides, and an electronic parking brake (EPB) that automatically locks the brake when the vehicle is stopped and automatically releases the brake when the vehicle starts to prevent the vehicle from being pushed back when the vehicle is stopped or starts on a hill.

Recently, the electro-mechanical brakes (EMB) have been developed and widely used. The EMBs have been developed as electronic parking brakes (EPB), but their use area is expanding to as a main brake replacement for conventional hydraulic brakes.

The EMB is a device that uses a motor-driven actuator mounted on a brake caliper to directly brake a vehicle using the driving force of the motor without a medium called brake fluid. The EMB has a similar mechanism to the electronic parking brake (EPB), but unlike the EPB, the EMB is mainly used for main braking, so higher braking responsiveness and operational durability are required than the EPB. In addition, EMB has a simpler structure than hydraulic brake, but has a faster braking response speed and more precise control, which can improve braking safety.

The background technology of the present disclosure is disclosed in Korean Patent Publication No. 10-2021-0131686 (published on Nov. 3, 2021).

### SUMMARY

As described above, because the electro-mechanical brake devices do not use brake fluid, all redundancy functions are electrically operable.

Therefore, redundancy configurations are required for each of the following: power supply, controller, and communication, that is, redundancy for power supply, redundancy for controller, and redundancy for communication.

In order to equip the vehicle with an electro-mechanical brake system as described above, it is necessary to ensure the implementation of electrical redundancy. Therefore, a vehicle-level concept for redundant low-voltage batteries and related power supply redundancy need to be established.

However, implementing such redundancy configurations may require changes to the overall vehicle architecture and lead to increased costs, which poses a challenge of delaying the adoption of electric brake systems.

The present disclosure has been devised to address the aforementioned problems. An aspect of the present disclosure provides a hybrid electro-mechanical brake apparatus and a control method therefor, which implements redundancy by applying an electro-mechanical brake (EMB) to the front wheels to generate front wheel braking force, and applying a hydraulic caliper to the rear wheels to generate rear wheel braking force through a wet-type pedal simulator and an electronic stability control (ESC) system.

A hybrid electro-mechanical brake apparatus according to an aspect of the present disclosure may include a pedal simulator configured to simulate a depression state of a brake pedal, a data collection module configured to collect vehicle information, a wheel controller configured to drive an electric caliper mounted on either front or rear wheels of a vehicle to generate braking force, a hydraulic control module configured to control a flow path to provide braking pressure to a hydraulic caliper mounted on a wheel different from a wheel on which the electric caliper is installed, based on the depression state of the pedal simulator, and a processor operatively coupled to the data collection module, the wheel controller, and the hydraulic control module. The processor may determine a vehicle posture based on the vehicle information input from the data collection module, drives the hydraulic control module and the wheel controller to perform posture control, and drives the wheel controller and the hydraulic control module according to braking conditions to generate the braking force.

The processor and the wheel controller may be connected based on Vehicle CAN communication.

The data collection module may collect the vehicle information from the vehicle control device based on the Vehicle CAN communication.

The wheel controller may include a left wheel controller configured to drive an electric caliper a the left wheel, and a right wheel controller configured to drive an electric caliper on a right wheel.

The left wheel controller and the right wheel controller independently may drive the electric calipers by receiving an electronic parking brake (EPB) signal and a pedal signal of the brake pedal.

The pedal simulator may be a wet-type pedal simulator.

The hydraulic control module may include a reservoir configured to store a brake fluid and supplies brake fluid to the pedal simulator, a first TCV valve configured to control inflow of the brake fluid discharged from the pedal simulator, a first inlet valve configured to supply the brake fluid introduced through the first TCV valve to the hydraulic caliper of the left wheel, a first outlet valve configured to recover the brake fluid recovered from the hydraulic caliper of the left wheel to the reservoir, a first hydraulic pump configured to pump the brake fluid recovered through the first outlet valve and supply the brake fluid through the first inlet valve to control pressure, a first ACV valve configured to control flow of hydraulic pressure between the first outlet valve and the first hydraulic pump, a second TCV valve configured to control the inflow of the brake fluid discharged from the pedal simulator, a second inlet valve configured to supply the brake fluid introduced through the second TCV valve to the hydraulic caliper of the right wheel, a second outlet valve configured to recover the brake fluid recovered from the hydraulic caliper on the right wheel to the reservoir, a second hydraulic pump configured to pump the brake fluid recovered through the second outlet valve and supply the brake fluid through the second inlet valve to control pressure, a second ACV valve configured to control flow of hydraulic pressure between the second outlet valve and the second hydraulic pump, and a motor configured to drive the first hydraulic pump and the second hydraulic pump.

The hybrid electro-mechanical brake apparatus may further include a pressure sensor configured to measure hydraulic pressure at one or more of input terminals of the first and second inlet valves.

The processor may be configured to maintain the first TCV valve and the second TCV valve in a closed state during normal operation, and to maintain the first TCV valve and the second TCV valve in an open state in the event of a failure.

A control method of a hybrid electro-mechanical brake apparatus according to an aspect of the present disclosure may include receiving, by a processor, vehicle information from a data collection module, determining, by the processor, a posture of a vehicle based on the vehicle information input from the data collection module and driving a hydraulic control module and a wheel controller to perform posture control, and driving, by the processor, the wheel controller and the hydraulic control module according to braking conditions based on the vehicle information to generate braking force.

According to the present disclosure, redundancy can be secured through the combination of an electric brake and a hydraulic brake by applying an electro-mechanical brake (EMB) to the front wheels and a hydraulic caliper to the rear wheels, with rear wheel braking force generated by a wet-type pedal simulator and an electronic stability control (ESC) system. In addition, the elimination of the front wheel hydraulic lines helps to suppress cost increases.

Furthermore, according to the present disclosure, since the front and rear braking actuators are separated, braking force distribution control based on an ideal braking curve becomes possible, allowing the advantages of an electric braking system to be realized while maintaining comparable cost competitiveness.

### BRIEF DESCRIPTION OF THE DRAWINGS

FIG. 1 is a block diagram illustrating a hybrid electro-mechanical brake apparatus according to an embodiment of the present disclosure.

FIG. 2 is a conceptual diagram illustrating a pedal simulator in a hybrid electro-mechanical brake apparatus according to an embodiment of the present disclosure.

FIG. 3 is a block diagram illustrating a hydraulic control module in a hybrid electro-mechanical brake apparatus according to an embodiment of the present disclosure.

FIG. 4 is a flowchart illustrating a control method of a hybrid electro-mechanical brake apparatus according to an embodiment of the present disclosure.

### DETAILED DESCRIPTION

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, embodiments that include other components in addition to the components described in the various embodiments are also included in the scope of the present disclosure.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, when a component is referred to as being “linked,” “coupled,” or “connected” to another component, it is understood that not only a direct connection relationship but also an indirect connection relationship through an intermediate component may also be included. In addition, when a component is referred to as “comprising” or “having” another component, it may mean further inclusion of another component not the exclusion thereof, unless explicitly described to the contrary.

In the present disclosure, the terms first, second, etc. are used only for the purpose of distinguishing one component from another, and do not limit the order or importance of components, etc., unless specifically stated otherwise. Thus, within the scope of this disclosure, a first component in one exemplary embodiment may be referred to as a second component in another embodiment, and similarly a second component in one exemplary embodiment may be referred to as a first component.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, exemplary embodiments that include other components in addition to the components described in the various embodiments are also included in the scope of the present disclosure.

Hereinafter, a hybrid electro-mechanical brake apparatus and a control method therefor according to an embodiment of the present disclosure will be described in detail below with reference to the accompanying drawings through various exemplary embodiments. It should be considered that the thickness of each line or the size of each component in the drawings may be exaggeratedly illustrated for clarity and convenience of description.

In addition, terms to be described below have been defined by taking into consideration their functions in the present disclosure, and may be different depending on a user or operator's intention or practice. Accordingly, such terms should be interpreted based on the overall contents of this specification.

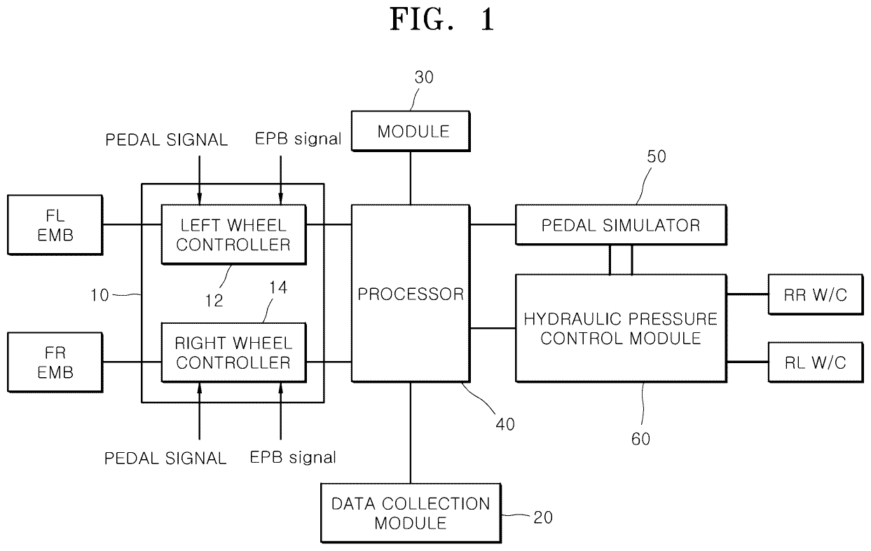

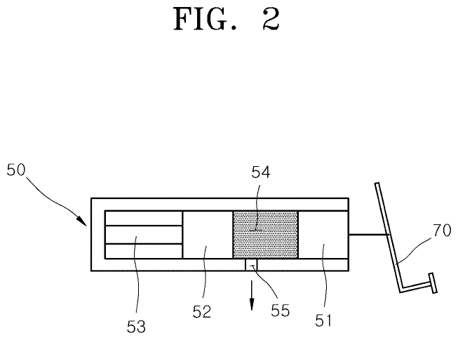

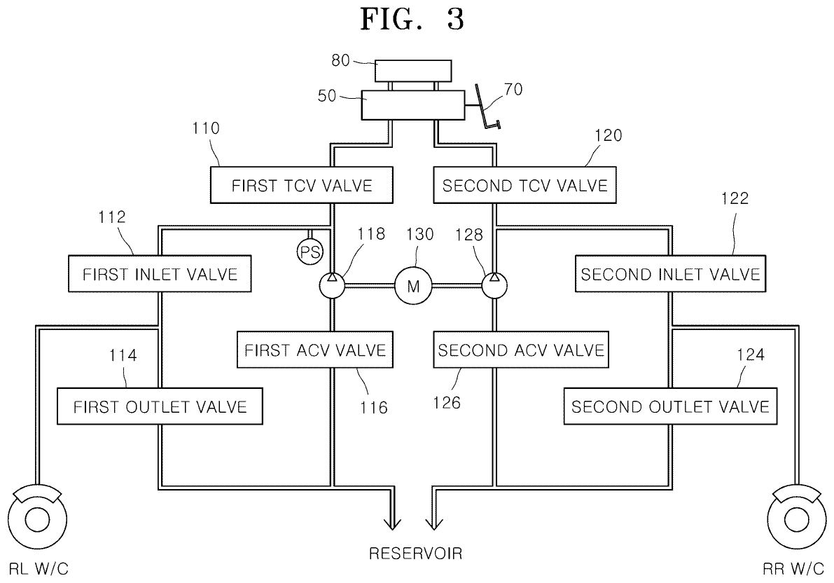

FIG. 1 is a block diagram illustrating a hybrid electro-mechanical brake apparatus according to an embodiment of the present disclosure. FIG. 2 is a conceptual diagram illustrating a pedal simulator in a hybrid electro-mechanical brake apparatus according to an embodiment of the present disclosure. FIG. 3 is a block diagram illustrating a hydraulic control module in a hybrid electro-mechanical brake apparatus according to an embodiment of the present disclosure.

As shown in FIG. 1, the hybrid electro-mechanical brake apparatus according to an embodiment of the present disclosure includes a pedal simulator 50, a data collection module 20, a wheel controller 10, a hydraulic pressure control module 60, a memory 30, and a processor 40.

The pedal simulator 50 simulates the depression state of a brake pedal 70.

The pedal simulator 50 is a wet-type pedal simulator, and for example, as shown in FIG. 2, may be configured as a damper 53 that not only increases the pressure of the brake liquid stored in a chamber 54 by an internal first piston 51 connected to the brake pedal 70 but also provides a reaction force to the movement of the brake pedal 70 by pushing a second piston 52.

In addition, a spring (not shown) for the return of the brake pedal 70 may be additionally installed together with the damper 53.

Furthermore, the pedal simulator 50 may include a pedal angle sensor (not shown) configured to measure a pedal angle of the brake pedal 70.

The data collection module 20 collects vehicle information.

That is, the data collection module 20 collects sensor values obtained by sensing operation state, steering state, and driving state of the vehicle. In this case, the data collection module 20 may include a sensor module or may collect the sensor values from a vehicle control device based on in-vehicle communication.

In this case, the in-vehicle communication may include CAN FD, Vehicle CAN, Local CAN, and the like. Vehicle CAN generally refers to a standard communication network designed for data exchange between various controllers (ECUs) within a whole vehicle, while Local CAN refers to a private CAN network applied to communication within specific areas (local domains) of the vehicle, such as the brakes, steering, engine, and transmission. CAN FD (Flexible Data Rate) is the latest CAN standard that overcomes the limitations of conventional CAN by improving data throughput and transmission speed.

The data collection module 20 may collect the sensor values from the vehicle control device based on Vehicle CAN communication. The sensor values may be transferred to ESC and also to the wheel controller corresponding to EMB of the front wheel through Vehicle CAN. The wheel controller of the front wheel and ESC may be connected through Local CAN.

For example, the vehicle information may include a brake pedal signal, a start signal, a door opening/closing signal, a wheel speed of each wheel, a brake lighting signal, a steering angle, a yaw rate, an EPB signal, and the like.

The wheel controller 10 drives an electric caliper mounted on one of the front and the rear wheels of the vehicle to generate braking force.

In this embodiment, the wheel controller 10 includes a left wheel controller 12 that drives the electric caliper FL EMB mounted on a left wheel of the front wheels and a right wheel controller 14 that drives the electric caliper FR EMB mounted on a right wheel of the front wheels.

In addition, each of the left wheel controller 12 and the right wheel controller 14 receives an EPB signal to drive the electric calipers FL EMB and FR EMB.

In other words, in this embodiment, because the electric calipers FL EMB and FR EMB mounted on the front wheels can also perform the parking brake function, even when the EPB signal is not input due to the abnormality of the processor 40, the EPB signal is independently received from the left wheel controller 12 and the right wheel controller 14, so parking braking can be generated even when either of the left wheel controller 12 and the right wheel controller 14 breaks down.

In this way, parking sprag can be deleted by the implementation of redundancy for parking braking, thereby reducing the cost.

In addition, the wheel controller 10 receives the pedal signal from the brake pedal 70 and drives the electric calipers FL EMB and FR EMB, so that even when an abnormality occurs in the processor 40, the electric calipers FL EMB and FR EMB can be driven to perform EMB braking.

The wheel controller 10 may be connected to the processor 40 based on in-vehicle communication, in particular Vehicle CAN communication, so that the wheel controller 10 may receive a control signal through the communication. However, even when an abnormality occurs in the communication or the abnormality occurs in the processor 40, the EPB signal and the pedal signal of the brake pedal 70 can be independently received, and thus parking braking or backup braking can be performed.

The hydraulic control module 60 may control the flow path to provide a braking pressure to the hydraulic caliper mounted on each of the wheels in which the electric caliper is installed and the other wheels based on the depressed state of the pedal simulator 50.

In the present embodiment, hydraulic calipers RL W/C and RR W/C may be installed on left and right wheels of the rear wheels, respectively. In this case, the size of a piston of the hydraulic calipers RL W/C and RR W/C installed on the rear wheels may be increased to a level equivalent to that of the hydraulic caliper installed on the front wheels, thereby enhancing hydraulic braking performance.

That is, by increasing the size of the piston to increase the hydraulic braking performance, the backup braking performance can be increased to ensure stability when emergency braking is performed only with the pedal force of a driver.

In particular, although the rear wheels do not require as much braking force as the front wheels under normal conditions, increasing the rear wheel braking force not only provides redundancy between the front electric brake and the rear hydraulic brake, but also enables a reduction in the required braking pressure to generate the same braking force under normal conditions, thereby improving durability performance.

Therefore, the advantages of electric braking systems can be easily applied to the ESC systems.

As shown in FIG. 3, the hydraulic control module 60 may be composed of a plurality of valves and pumps for supplying, pressing, and recovering brake fluid to the hydraulic caliper RL W/C on the left wheel and the hydraulic caliper RR W/C on the right wheel.

That is, the hydraulic control module 60 includes a reservoir 80 that stores the recovered brake fluid and supplies the brake fluid to the pedal simulator 50, and a first TCV valve 110 and a second TCV valve 120 that control the inflow of the brake fluid discharged from the pedal simulator 50.

At this time, the first TCV valve 110 and the second TCV valve 120 maintain closed states during normal braking to prevent braking fluid from being transmitted from the pedal simulator 50 to the wheels, thereby being used to press the damper 53 of the pedal simulator 50 to enable virtual pedal fill formation.

On the other hand, in the event of a failure in the processor 40, the first and second TCV valves 110 and 120 open, and when the driver presses the brake pedal 70, brake fluid is discharged and supplied to the hydraulic calipers RL W/C and RR W/C of the left and right rear wheels, thereby generating braking force.

Since only the hydraulic calipers RL W/C and RR W/C mounted on the rear wheels are pressurized via the pedal simulator 50, braking force can be generated with a relatively small amount of brake fluid. Accordingly, it is not necessary to provide additional valves or a booster in the pedal simulator 50 for pressurization.

At this time, the hydraulic line for supplying brake fluid, introduced through the first TCV valve 110, to the hydraulic caliper RL W/C of the left wheel may include a first inlet valve 112 that supplies the brake fluid introduced through the first TCV valve 110 to the hydraulic caliper RL W/C of the left wheel, a first outlet valve 114 that returns the brake fluid recovered from the hydraulic caliper RL W/C of the left wheel to the reservoir 80, a first hydraulic pump 118 that pumps the brake fluid recovered through the first outlet valve 114 and supplies the brake fluid through the first inlet valve 112 to control the pressure, and a first ACV valve 116 disposed between the first outlet valve 114 and the first hydraulic pump 118 to control the flow of hydraulic pressure. The first ACV valve 116 may be configured as a check valve.

Furthermore, the hydraulic line for supplying the brake fluid, introduced through the second TCV valve 120, to the hydraulic caliper RR W/C of the right wheel may include a second inlet valve 122 that supplies the brake fluid introduced through the second TCV valve 120 to the hydraulic caliper RR W/C of the right wheel, a second outlet valve 124 that returns the brake fluid recovered from the hydraulic caliper RR W/C of the right wheel to the reservoir 80, a second hydraulic pump 128 that pumps the brake fluid recovered through the second outlet valve 124 and supplies the brake fluid through the second inlet valve 122 to control the pressure, and a second ACV valve 126 disposed between the second outlet valve 124 and the second hydraulic pump 128 to control the flow of hydraulic pressure. The second ACV valve 126 may be configured as a check valve.

In addition, a motor 130 that drives the first hydraulic pump 118 and the second hydraulic pump 128 may be included.

In this case, the motor 130 may be driven by the processor 40 to generate braking force distributed to the rear wheels during braking or to generate braking force distributed to the rear wheels for posture control of the vehicle.

Additionally, a pressure sensor PS may be provided at the input end of the first inlet valve 112 to measure the hydraulic pressure, and may supply the measured value to the processor 40 so that the braking force can be controlled based on the hydraulic pressure pressurized through the first hydraulic pump 118 between the first TCV valve 110 and the first inlet valve 112. In this case, the pressure sensor PS may alternatively be installed between the second inlet valve 122 and the second TCV valve 120.

The memory 30 stores an execution program for driving the hybrid electric brake apparatus, stores an algorithm related to the operation of the hybrid electric brake apparatus, and the stored information may be selected by the processor 40 as needed.

That is, various types of data generated during the execution of an operating system or application (program or applet) for driving the hybrid electric braking system are stored in the memory 30. In this case, the memory 30 may be implemented as a nonvolatile memory, a volatile memory, a flash memory, a hard disk drive (HDD), a solid state drive (SSD), or the like. In addition, the memory 30 may perform reading/writing/correction/deletion/update of data by the processor 40.

The processor 40 is operatively coupled to the data collection module 20, the wheel controller 10, the hydraulic control module 60, and the memory 30, and may copy various programs stored in the memory 30 to RAM and execute the programs to perform various operations in order to control the overall operation of the hybrid electric braking system.

Here, although the processor 40 is described as including a single CPU, the processor 40 may be implemented with a plurality of CPUs (or DSPs, SoCs, etc.) in practice.

In various embodiments, the processor 40 may be implemented as a digital signal processor (DSP), a microprocessor, and a time controller (TCON) that processes digital signals. However, the present disclosure is not limited thereto, and may include one or more of a central processing unit (CPU), a micro controller unit (MCU), a micro processing unit (MPU), a controller, an application processor (AP), a communication processor (CP), an ARM processor, or may be defined in a corresponding term. In addition, the processor 40 may be implemented as a System on Chip (SoC) with a built-in processing algorithm, a large scale integration (LSI), or in the form of a field programmable gate array (FPGA).

That is, the processor 40, after executing the execution program stored in the memory 30, may determine the vehicle posture based on vehicle information input from the data collection module 20, and perform posture control by operating the hydraulic control module 60 and the wheel controller 10. The processor 40 may also generate braking force by operating the wheel controller 10 and the hydraulic control module 60 according to braking conditions.

Additionally, when a fault occurs in the wheel controller 10, the processor 40 may drive the motor 130 of the hydraulic control module 60 to generate braking force by supplying brake fluid to the left wheel hydraulic caliper RL W/C and the right wheel hydraulic caliper RR W/C through the first hydraulic pump 118 and the second hydraulic pump 128.

Meanwhile, when a fault occurs in the processor 40, braking can be generated not only by driving the electric calipers FL EMB and FR EMB based on the pedal signal of the brake pedal 70 that is independently input to the wheel controller 10, but also by opening the first and second TCV valves 110 and 120 of the hydraulic control module 60, such that brake fluid is discharged by the driver's pedal force and supplied to the left wheel hydraulic caliper RL W/C and the right wheel hydraulic caliper RR W/C to generate braking force.

As described above, according to an embodiment of the present disclosure, the hybrid electric brake system applies electro-mechanical brake (EMB) to the front wheels and a hydraulic caliper to the rear wheels. By generating rear wheel braking force through a wet-type pedal simulator and an electronic stability control (ESC), redundancy is ensured through both electric and hydraulic braking systems. In addition, the elimination of the front wheel hydraulic line helps to suppress cost increases. Since the front and rear wheel brake actuators are separated, braking force distribution control based on an ideal braking curve is enabled, thereby allowing the advantages of the electric braking system to be realized with competitive cost efficiency.

In addition, according to the present disclosure, parking sprags can be deleted by implementing redundancy for parking braking, thereby reducing costs.

In addition, according to the present disclosure, by increasing the size of the piston of the rear wheel caliper to increase the hydraulic braking performance, it is possible to secure stability by increasing the backup braking performance when emergency braking is performed only with the driver's pedal force, and to lower the braking pressure required to generate the same braking force in normal situations, thereby improving durability performance.

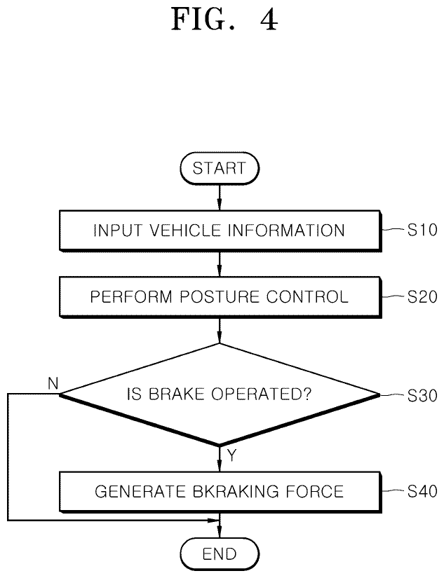

FIG. 4 is a flowchart illustrating a control method of a hybrid electronic mechanical brake system according to an embodiment of the present disclosure.

As shown in FIG. 4 along with FIG. 1, in the control method of the hybrid electronic mechanical brake system according to an embodiment of the present disclosure, the processor 40 executes and drives an execution program built into the memory 30 after starting and receives vehicle information from the data collection module 20 (S10).

After receiving the vehicle information in operation S10, the processor 40 determines the posture of the vehicle based on the vehicle information and performs posture control by driving the hydraulic control module 60 and the wheel controller 10 (S20).

The processor determines a brake operation while driving and performing posture control of the vehicle in operation S20 (S30).

When the brake pedal 70 is pressed in operation S30 and brake is operated, the processor 40 drives the wheel controller 10 and the hydraulic control module 60 based on the pedal signal of the brake pedal 70 to generate braking force (S40).

In this case, the braking force may be ideally distributed through the wheel controller 10 of the front wheel and the hydraulic control module 60 of the rear wheel to generate the braking force.

According to an embodiment of the present disclosure, the hybrid electric brake apparatus applies electro-mechanical brake (EMB) to the front wheels and a hydraulic caliper to the rear wheels. By generating rear wheel braking force through a wet-type pedal simulator and an electronic stability control (ESC), redundancy is ensured through both electric and hydraulic braking systems. In addition, the elimination of the front wheel hydraulic line helps to suppress cost increases. Since the front and rear wheel brake actuators are separated, braking force distribution control based on an ideal braking curve is enabled, thereby allowing the advantages of the electric braking system to be realized with competitive cost efficiency.

Although exemplary embodiments of the disclosure have been disclosed for illustrative purposes, those skilled in the art will appreciate that various modifications, additions and substitutions are possible, without departing from the scope and spirit of the disclosure as defined in the accompanying claims. Thus, the true technical scope of the disclosure should be defined by the following claims.

What is claimed is:

1. A hybrid electro-mechanical brake apparatus comprising:
a pedal simulator configured to simulate a depression state of a brake pedal;
a data collection module configured to collect vehicle information;
a wheel controller configured to drive an electric caliper mounted on one of front and rear wheels of a vehicle to generate braking force;
a hydraulic control module configured to control a flow path to provide braking pressure to a hydraulic caliper mounted on a first wheel different from a second wheel on which the electric caliper is installed, based on the depression state of the pedal simulator; and
a processor operatively coupled to the pedal simulator, the data collection module, the wheel controller, and the hydraulic control module,
wherein the processor is configured to determine a vehicle posture based on the vehicle information collected from the data collection module, drive the hydraulic control module and the wheel controller to perform posture control, and drive the wheel controller and the hydraulic control module according to braking conditions to generate the braking force.

2. The hybrid electro-mechanical brake apparatus of claim 1, wherein the processor and the wheel controller are connected based on Vehicle CAN communication.

3. The hybrid electro-mechanical brake apparatus of claim 1, wherein the data collection module collects the vehicle information from a vehicle control device based on Vehicle CAN communication.

4. The hybrid electro-mechanical brake apparatus of claim 1, wherein the wheel controller includes:
a left wheel controller configured to drive a first electric caliper a left wheel; and
a right wheel controller configured to drive a second electric caliper on a right wheel.

5. The hybrid electro-mechanical brake apparatus of claim 4, wherein the left wheel controller and the right wheel controller independently drive the first electric caliper and the second electric caliper by receiving an electronic parking brake (EPB) signal and a pedal signal of the brake pedal.

6. The hybrid electro-mechanical brake apparatus of claim 1, wherein the pedal simulator is a wet-type pedal simulator.

7. The hybrid electro-mechanical brake apparatus of claim 1, wherein the hydraulic control module includes:
a reservoir configured to store a brake fluid and supply the brake fluid to the pedal simulator;
a first TCV valve configured to control inflow of the brake fluid discharged from the pedal simulator;
a first inlet valve configured to supply the brake fluid introduced through the first TCV valve to the hydraulic caliper of a left wheel of the first wheels;
a first outlet valve configured to recover the brake fluid recovered from the hydraulic caliper of the left wheel to the reservoir;
a first hydraulic pump configured to pump the brake fluid recovered through the first outlet valve and supply the brake fluid through the first inlet valve to control pressure;
a first ACV valve configured to control flow of the brake fluid between the first outlet valve and the first hydraulic pump;
a second TCV valve configured to control the inflow of the brake fluid discharged from the pedal simulator;
a second inlet valve configured to supply the brake fluid introduced through the second TCV valve to the hydraulic caliper of a right wheel of the first wheels;
a second outlet valve configured to recover the brake fluid recovered from the hydraulic caliper on the right wheel to the reservoir;
a second hydraulic pump configured to pump the brake fluid recovered through the second outlet valve and supply the brake fluid through the second inlet valve to control pressure;
a second ACV valve configured to control flow of the brake fluid between the second outlet valve and the second hydraulic pump; and
a motor configured to drive the first hydraulic pump and the second hydraulic pump.

8. The hybrid electro-mechanical brake apparatus of claim 7, further comprises a pressure sensor configured to measure hydraulic pressure at one or more of input terminals of the first and second inlet valves.

9. The hybrid electro-mechanical brake apparatus of claim 7, wherein the processor is configured to maintain the first TCV valve and the second TCV valve in a closed state during normal operation, and to maintain the first TCV valve and the second TCV valve in an open state in response to a failure.

10. A control method of a hybrid electro-mechanical brake apparatus, comprising:
receiving, by a processor, vehicle information from a data collection module;
determining, by the processor, a posture of a vehicle based on the vehicle information received from the data collection module,
driving, by the processor, a hydraulic control module and a wheel controller to perform posture control; and
driving, by the processor, the wheel controller and the hydraulic control module according to braking conditions based on the vehicle information to generate braking force.
